(19) United States
(12) Patent Application Publication
(10) Pub. No.: US 2026/0071148 A1
(43) Pub. Date: Mar. 12, 2026

(54) FLUORO-SURFACTANT AND FLUORO-POLYMER FREE FLOOR CARE COMPOSITIONS AND USES THEREOF

(71) Applicant: ECOLAB USA INC., Saint Paul, MN (US)

(72) Inventors: David Riehm, Eagan, MN (US); Traci Gioino, Maplewood, MN (US); Avila Abelseth, Eagan, MN (US); Wendy Lo, Woodbury, MN (US)

(21) Appl. No.: 19/319,996

(22) Filed: Sep. 5, 2025

Related U.S. Application Data
(60) Provisional application No. 63/691,431, filed on Sep. 6, 2024.

(51) Int. Cl. C11D 3/37; B08B 1/30; B08B 3/08; C11D 1/72; C11D 3/20; C11D 3/36; C11D 3/43

(52) U.S. Cl. CPC C11D 3/3757; B08B 1/30; B08B 3/08; C11D 1/72; C11D 3/2093; C11D 3/362; C11D 3/43

(57) ABSTRACT

Hard surface, namely floor coating compositions free of fluoro-surfactants and free of zinc cross-link agents are disclosed. More particularly, hard surface, namely floor coating compositions containing an organic polymer comprising (i) styrene or vinyl toluene and at least one monoethylenically unsaturated acid or anhydride, (ii) acrylic polymers or modified acrylic polymers, or (iii) combinations thereof as the floor coating material with a plasticizing agent, solvent and/or a coalescent and/or cosolvent, without the use of zinc cross-link agents and fluoro-surfactants are disclosed. The aqueous compositions and methods of use provide desired floor coating characteristics with enhanced sustainability profiles.

### CROSS REFERENCE TO RELATED APPLICATION

This application claims priority under 35 U.S.C. § 119 to Provisional Application Ser. No. 63/691,431, filed Sep. 6, 2024, which is herein incorporated by reference in its entirety.

### TECHNICAL FIELD

This invention relates to hard surface, namely floor coating compositions that are free of fluoro-surfactants and/or fluoro-polymers. More particularly, this invention relates to hard surface, namely floor coating compositions containing an organic polymer or copolymers free of zinc cross-link agents comprising (i) styrene or vinyl toluene and at least one monoethylenically unsaturated acid or anhydride, (ii) acrylic polymers or modified acrylic polymers, or (iii) combinations thereof as the floor coating material with a plasticizing agent, solvent and/or a coalescent and/or cosolvent, without the use of fluoro-surfactants. The aqueous compositions and methods of use provide desired floor coating characteristics with enhanced sustainability profiles.

### BACKGROUND

In many industrial and commercial businesses, cleaning and maintenance of the floors is an ongoing endeavor. Grocery stores, food production facilities, commercial kitchens, commercial laundry facilities, hotels, restaurants, office buildings, public restrooms, etc. are examples of facilities in which the upkeep of the floor is a continuing occupation. The presence of spills, dirt, or other floor conditions can affect the safety of persons in the area, contribute to an unsightly environment, and/or increase wear and tear on the floor itself.

A clean, shiny and non-slip floor surface is desirable to consumers. Floor surfaces are often polished for a glossy appearance and then maintained 50 through a cleaning process, such as daily cleaning with a daily cleaner or daily cleaner/conditioner. After the surface of the floor is polished, the gloss tends to decrease with time and/or use.

Aqueous coating compositions are used as protective coatings for various substrates such as wood, stone, plastic and the like. Such compositions typically contain a film-forming polymer. That polymer forms a continuous protective coating over the substrate, often in conjunction with other additive materials such as other polymers, resins, waxes, pigments, dyes, ultraviolet light absorbing agents and the like, to help protect it from damage caused by the sun, abrasion, foot traffic, pressure, soiling, and so forth. The film-forming polymers are typically selected for their physical properties such as water resistance, flexibility, removability, hardness, resilience, toughness, scratch and marking resistant (e.g. black heel marks) to fit the needs of the substrate being protected and the environment in which the coating will be used.

Existing hard surface and floorcare compositions provide these efficacious attributes. However recent sustainability, environmental and/or safety concerns limit or restrict the use of polymers, surfactants, and other components in the compositions. For example, it is desirable to remove fluoro-surfactants, including perfluoroalkyl surfactants, that are known to provide the desired water resistance, flexibility, removability, hardness, resilience, toughness, scratch and marking resistant in floor care compositions. Moreover, consumers desire provides with Green Seal certification, indicating products are among the safest and most sustainable in the marketplace. This can also significantly modify the types of polymers, surfactants, and other components in the compositions and present challenges in product formulations that achieve the same efficacy outcomes.

Accordingly, there exists a need in the art for hard surface and floorcare compositions that are free of fluoro-surfactants and/or fluoro-polymers while retaining at least the same level of efficacy of compositions with the fluoro-surfactants.

There is a further need in the art for hard surface and floorcare compositions that are free of zinc cross-link agents and fluoro-surfactants while retaining at least the same level of efficacy of compositions with the zinc cross-link agents and fluoro-surfactants.

It is therefore an object of this disclosure to provide aqueous compositions that achieve these standards of efficacy while being sustainable and/or Green Seal approved.

Other objects, embodiments and advantages of this disclosure will be apparent to one skilled in the art in view of the following disclosure, the drawings, and the appended claims.

### SUMMARY

It is a primary object, feature, and/or advantage of the present disclosure to improve on or overcome the deficiencies in the art to provide hard surface and floorcare compositions that are free of fluoro-surfactants and/or fluoro-polymers while retaining at least the same level of efficacy or providing improved efficacy of compositions with the fluoro-surfactants. Moreover, it is an object of this disclosure to provide aqueous compositions that achieve these standards of efficacy while being sustainable and/or Green Seal approved, which requires the compositions to be free of both zinc cross-link agents and fluoro-surfactants.

According to some aspects of the present disclosure, aqueous compositions comprise: a nonionic alcohol alkoxylate surfactant; an organic polymer or copolymers comprising (i) styrene or vinyl toluene and at least one monoethylenically unsaturated acid or anhydride, (ii) acrylic polymers or modified acrylic polymers, or (iii) combinations thereof; a plasticizing agent comprising tributoxyethyl phosphate and benzoate esters; and a solvent and optionally a coalescent and/or cosolvent; wherein the compositions are free of fluoro-surfactants, free of zinc cross-link agents, and free of fluoro-polymers; and wherein the composition comprises between about 15 wt-% to about 35 wt-% of solids.

According to some additional aspects of the present disclosure, methods for cleaning a hard surface, preferably a floor surface comprise: applying an aqueous composition as described according to the various embodiments herein to the hard surface or floor surface. Beneficially the compositions provide desired efficacy without inclusion of the fluoro-surfactants and zinc cross-link agents.

According to some other aspects of the present disclosure, a kit comprises: an aqueous composition as described according to the various embodiments herein; a container and/or applicator device; and optionally instructions for use of the kit.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1A is a graph showing the percent area of black rubber marks on tiles coated with inline formula 1 and aqueous composition 1.

FIG. 1B is a graph showing the percent area of black rubber marks on tiles coated with inline formula 2 and aqueous composition 2.

FIG. 1C is a graph showing the percent area of black rubber marks on tiles coated with inline formula 2 and aqueous composition 2.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been found and described herein that aqueous compositions for hard surface, namely floorcare, that are free of zinc cross-link agents and fluoro-surfactants can retain at least the same level of efficacy of compositions with the zinc cross-link agents and fluoro-surfactants. Moreover, it is an object of this disclosure to provide aqueous compositions that achieve these standards of efficacy while being sustainable products, such as those with Green Seal approval.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The compositions, methods and kits of the present disclosure may comprise, consist essentially of, or consist of the components and ingredients of the present disclosure as well as other ingredients described herein. As used herein, “consisting essentially of” means that the compositions, methods, and kits may include additional steps, components or ingredients, but only if the additional steps, components or ingredients do not materially alter the basic and novel characteristics of the claimed compositions, methods, and kits.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, surface tension, molecular weight, contact angle, temperature, pH, molar ratios, other measurements described herein, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups. In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “analog” means a molecular derivative of a molecule. The term is synonymous with the terms “structural analog” or “chemical analog.”

As used herein, the term “between” is inclusive of any endpoints noted relative to a described range.

The term “configured” describes structure capable of performing a task or adopting a particular configuration. The term “configured” can be used interchangeably with other similar phrases, such as constructed, arranged, adapted, manufactured, and the like.

As used herein, the phrase “consumer” refers to a non-institutional use as well as the purchaser who intends to use a product or a commodity for a non-industrial and business use, such as a use of a product within a consumer's own home.

As used herein, the term “exemplary” refers to an example, an instance, or an illustration, and does not indicate a most preferred embodiment unless otherwise stated.

As used herein, the term “floor” refers to any flooring surface whether coated with a polymeric coating or uncoated, such as, for example stone, ceramic, plastic, wood, linoleum, vinyl composite tile (VCT) or the like.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “hard surface” refers to a solid, substantially non-flexible surface such as a counter top, tile, floor, wall, panel, window, plumbing fixture (e.g. drain), kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “institutional” is meant that the use or operations are located in a commercial or service industry including but not limited to hotels, motels, hospitals, nursing homes, restaurants, health clubs, and the like.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%.

The term “surfactant” or “surface active agent” refers to an organic chemical that when added to a liquid changes the properties of that liquid at a surface.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Compositions

According to embodiments, the aqueous compositions for hard surface, namely floor care to protect flooring surfaces provide a polymer coating. The aqueous compositions include a nonionic alcohol alkoxylate surfactant, organic polymer(s) free of zinc cross-link agents, plasticizing agent, and solvent(s), wherein the composition is free of fluoro-surfactants and/or fluoro-polymers. In embodiments, the aqueous compositions further comprise a coalescent and/or cosolvent. In further embodiments, the aqueous compositions further comprise additional functional ingredients and can be provided as concentrate or use compositions. Exemplary aqueous compositions are shown in Table 1 in weight percentage.

The aqueous compositions have a pH between about 7 to about 9.5 as a concentrate. According to embodiments, the pH for application of use is between about 7 to about 9.5, or about 7 to about 9, or preferably between about 7 to about 8.5.

While the components may have a percent actives of 100%, it is noted that Table 1 does not recite the percent actives of the components, but rather, recites the total weight percentage of the raw materials (i.e. active concentration plus inert ingredients, such as water).

TABLE 1

| | | Second | |
|---|---|---|---|
| | First Exemplary | Exemplary | Third Exemplary |
| Material | Range wt.-% | Range wt.-% | Range wt.-% |
| Nonionic alcohol | 0.01-5 | 0.1-5 | 0.1-2 |
| alkoxylate | | | |
| surfactant | | | |
| Organic Polymer(s) | 20-60 | 30-60 | 30-50 |
| Plasticizing | 0.1-10 | 0.5-10 | 0.5-5 |
| Agent(s) | | | |
| Water | 10-60 | 20-60 | 30-60 |
| Additional | 0-50 | 0.01-50 | 1-20 |
| Functional | | | |
| Ingredients | | | |

Beneficially the fluoro-surfactant free compositions also include less than 1% volatile organic compounds (VOCs). VOCs have been found to be a major contributing factor to ozone, a common air pollutant. Ozone is not emitted into the air, but actually formed in the atmosphere through a photo-chemical process. VOCs in the air react with oxides of nitrogen and sunlight to form ozone. As a result it is a benefit to reduce VOC levels of chemical compositions to improve air quality.

### Nonionic Alcohol Alkoxylate Surfactant

The aqueous compositions comprise a nonionic surfactant, namely an alcohol alkoxylate surfactant. Nonionic surfactants are those characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Alcohol alkoxylate surfactants include linear alcohol ethoxylates. Additional alcohol alkoxylates include alkylphenol ethoxylates, branched alcohol ethoxylates, secondary alcohol ethoxylates, alcohol ethoxylate propoxylates, alcohol propoxylates, alcohol propoxylate ethoxylate propoxylates, alcohol ethoxylate butoxylates, castor oil ethoxylates, alkylamine ethoxylates, tallow amine ethoxylates, fatty acid ethoxylates, sorbitol oleate ethoxylates, end-capped ethoxylates, or mixtures thereof.

In a preferred embodiment, the alcohol alkoxylate is an alcohol ethoxylate having the following formula: R₂—O-(EO)x-H, wherein R₂ is a C10-C14 alkyl, or preferably a C12-C14 alkyl, and wherein x is 3-9, or preferably x is 3-6. Exemplary commercially available nonionic alcohol ethoxylate surfactants include ethoxylated tridecyl alcohols, such as those sold under the trade name TDA, e.g., TDA 6; C12-C14 alcohol ethoxylates having 3-9, 3-8, or preferably 3-6 moles EO. Additional examples of like commercially available nonionic alcohol ethoxylate surfactants are available under the trade names Lutensol™, Dehydol™, Neodol™.

In some embodiments, the nonionic alcohol alkoxylate surfactant is included in the composition at an amount of at least about 0.01 wt-% to about 5 wt-%, about 0.1 wt-% to about 5 wt-%, about 0.1 wt-% to about 2 wt-%, about 0.1 wt-% to about 1 wt-%, or about 0.1 wt-% to about 0.5 wt-%. In addition, without being limited according to the disclosure, all ranges recited are inclusive of the numbers defining the range and include each integer within the defined range.

### Organic Polymer(s) or Copolymers

The aqueous compositions comprise an organic polymer(s) or copolymers that are not crosslinked through zinc metal ions that provide a film forming component for the compositions. The organic polymer or copolymers comprises (i) styrene or vinyl toluene and at least one monoethylenically unsaturated acid or anhydride, (ii) acrylic polymers or modified acrylic polymers, or (iii) combinations thereof. Beneficially the organic polymer is free of zinc cross-link agents. The polymers are generally provided as an emulsion.

The organic polymers may include a vinyl component. The vinyl component may be a styrene or a monoalkenyl aromatic monomer such as methyl styrene or tertiary butyl styrene. In a specific embodiment, the acrylic polymer emulsion comprises a styrene. Preferably the organic polymers can include copolymers of styrene or vinyl toluene with at least one monoethylenically unsaturated acid or anhydride, such as styrene-maleic anhydride resins, rosin/maleic anhydride adducts which are condensed with polyols, and the like.

The organic polymers can include acrylic polymers or modified acrylic polymers. Exemplary acrylic copolymers include, for example, methyl methacrylate/butyl acrylate/methacrylic acid (MMA/BA/MAA) copolymers, methyl methacrylate/butyl acrylate/acrylic acid (MMA/BA/AA) polymers, and the like. Suitable acrylic polymers may further include, but are not limited to polymers, copolymers, or terpolymers of acrylic acid or methacrylic acid with esters of acrylic or methacrylic acid, hydroxyethyl methacrylate methacrylonitrile, and acrylonitrile. Additional monomers may also be used. For example, additional monomers may include methyl methacrylate, butyl acrylate, ethyl acrylate, and 2-ethylhexyl acrylate. Further, additional unsaturated acid monomers may be substituted in part for the methacrylic acid. Suitable unsaturated acid monomers may include, but are not limited to, maleic acid, crotonic acid, fumaric acid, and itaconic acid.

Suitable commercially available styrene-acrylic polymers include, but are not limited to, styrene/methyl methacrylate/butyl acrylate/methacrylic acid (S/MMA/BA/MMA) copolymers, styrene/methyl methacrylate/butyl acrylate/acrylic acid (S/MMA/BA/AA) copolymers, and the like.

In preferred embodiments, the organic polymer(s) comprises a homopolymer or copolymer of acrylic and methacrylic acids (or modified acrylic and methacrylic acids), a copolymer of styrene and at least one member selected from the group consisting of acrylic and methacrylic acids (or modified acrylic and methacrylic acids), a homopolymer or copolymer of vinyl acetate, or combinations thereof. Additional suitable copolymers include, but are not limited to, styrene/butyl acrylate/methacrylic acid, styrene/ethyl acrylate/methacrylic acid, styrene/butyl acrylate/ethyl acrylate acid, and styrene/butyl acrylate acrylate/ethyl methacrylic acid. Other suitable copolymers include, but are not limited to, styrene/butyl acrylate/acrylate/acrylic acid, styrene/ethyl acrylate/acrylic acid, and methyl/styrene styrene/butyl acrylate/ethyl acrylate/methacrylic acid/acrylic acid.

Exemplary organic polymer(s) are commercially-available for example as poly(acrylic/styrene) emulsions sold as Mor Glo 8, Mor Glo 19, Mor Glo HSN, and are available from Omnova Solutions, Fairlawn Ohio. Further exemplary organic polymer(s) include Duraplus™ 3 and Duraplus™ 3Lo, and various polymers under the tradename Rhoplex™.

Beneficially the organic polymer is free of zinc cross-link agents. The compositions containing the organic polymer and at least the nonionic alcohol alkoxylate surfactant are able to overcome the need for the polyvalent zinc compounds conventionally used as cross-link agents for organic polymers. Conventional floorcare compositions crosslink the polymers in the film to increase efficacy of the finish, such as coating removability with alkaline chemistries, and the detergent resistance of the finish.

The organic polymers in the aqueous composition according to the invention are free of zinc metals for cross-linking agents, and in further embodiments may be further free of other polyvalent metals for cross linking agents, including beryllium, cadmium, copper, magnesium, zirconium, barium, strontium, aluminum, bismuth, antimony, lead, cobalt, iron, and nickel. These polyvalent metal compounds are typically a metal complex, a metal salt of an organic acid, or a metal chelate.

The organic polymers in the aqueous composition according to the invention are free of chitosan, xanthan gum, guar gum and similar polymers.

In some embodiments, the organic polymer(s) or copolymers are included in the composition at an amount of at least about 20 wt-% to about 60 wt-%, about 30 wt-% to about 60 wt-%, or about 30 wt-% to about 50 wt-%. In addition, without being limited according to the disclosure, all ranges recited are inclusive of the numbers defining the range and include each integer within the defined range.

### Plasticizing Agent(s)

The aqueous compositions comprise plasticizing agent(s) comprising tributoxyethyl phosphate (TBEP) and benzoate esters. Beneficially, the plasticizer facilitates film formation at desired temperatures when the composition is applied to a substrate. A fugitive or semi-fugitive plasticizer is a plasticizer that at least partially evaporates as the coating dries. Permanent plasticizers do not evaporate substantially. Mixtures of fugitive and permanent plasticizers can be used in the aqueous compositions. The particular plasticizer and the amount used are chosen in accordance with the demand for compatibility with the formulation, efficiency in lowering the film-forming temperature, and clarity of the coating.

In preferred embodiments, the plasticizing agent comprises from about 40 wt-% to about 60 wt-% of the tributoxyethyl phosphate (TBEP) and from about 40 wt-% to about 60 wt-% of the benzoate esters. In some embodiments the TBEP to benzoate esters blend (based on a weight ratio) in the plasticizer agent is greater than zero to less than about 1.5.

Exemplary benzoate esters comprise or consist essentially of benzoate of 8-carbon monocarboxylic acid (e.g. 2-ethylhexyl benzoate (2-EHB), a preferred benzoic acid ester of an 8-carbon mono-hydric alcohol), diethylene glycol dibenzoate (DEGDB), and diethylene glycol monobenzoate (DEGMB). The 8-carbon monocarboxylic acid is represented by the formula PhCO(O)R¹ where Ph represents a phenyl radical and R¹ represents a linear or branched alkyl radical containing 8 carbon atoms. In a preferred embodiment R¹ is a 2-ethylhexyl. Various benzoate esters blends are commercially available.

The plasticizing agent provides beneficial leveling and gloss properties along with soil resistance that provide a floor coating composition with reduced phosphorus, that performs well in terms of leveling and gloss and further has improved soil resistance.

In some embodiments fugitive plasticizers or coalescents can be excluded due to use of the tributoxyethyl phosphate and benzoate esters, these include, for example, the monobutyl, monoethyl, monomethyl or other monoalkyl ethers of diethylene glycol or diproplyleneglycol, isophorone, benzyl alcohol, butyl cellosolve, and 3-methoxybutanol-1. Permanent plasticizers include, for example, benzyl butyl phthalate, dibutyl phthalate, dimethyl phthalate, triphenyl phosphate, 2-ethyl hexyl benzylphthalate, fatty oil acid esters of caprolactam, acetyl tributyl citrate, toluene ethyl sulfonamide, tributoxyethyl phosphate, and tributyl phosphate. Beneficially the exclusion of the various additional plasticizers or coalescents provides a reduced phosphorus floor coating composition that is a more environmentally friendly product.

In some embodiments, the plasticizing agent(s) is included in the composition at an amount of at least about 0.1 wt-% to about 10 wt-%, about 0.5 wt-% to about 10 wt-%, about 0.5 wt-% to about 5 wt-%, or about 0.5 wt-% to about 3 wt-%. In addition, without being limited according to the disclosure, all ranges recited are inclusive of the numbers defining the range and include each integer within the defined range.

### Solvents

The aqueous compositions comprise water and optionally additional cosolvents.

### Water

The aqueous compositions comprise water. In some embodiments, an additional the water is included in the composition at an amount of at least about 10 wt-% to about 60 wt-%, about 20 wt-% to about 60 wt-%, or about 30 wt-% to about 60 wt-%. In addition, without being limited according to the disclosure, all ranges recited are inclusive of the numbers defining the range and include each integer within the defined range.

### Cosolvent(s)

The aqueous compositions comprise water and can further include additional cosolvents. Exemplary cosolvents can include glycol ethers, including for example diethyleneglycolmonoctheyl ether, monopropyleneglycolmonopropyl ether, dipropyleneglycolmonobutyl ether, monopropyleneglycolmonobutyl ether, ethyleneglycolmonohexyl ether, ethyleneglycolmonobutyl ether, diethyleneglycolmonohexyl ether, monoethyleneglycolmonopropyl ether-, diethyleneglycolmonobutyl ether, and mixtures thereof.

Various other cosolvents include oils, benzyl alcohol, n-hexanol, phthalic acid esters of C1-4 alcohols, butoxy propanol, Butyl Carbitol® and 1 (2-n-butoxy-1-methylethoxy) propane-2-ol (also called butoxy propoxy propanol or dipropylene glycol monobutyl ether), hexyl diglycol (Hexyl Carbitol®, butyl triglycol, isopropyl alcohol, diols such as 2.2,4-trimethyl-1,3-pentanediol, and mixtures thereof, can also be used.

In some embodiments, an additional cosolvent is included in the composition at an amount of at least about 0.1 wt-% to about 20 wt-%, about 0.1 wt-% to about 10 wt-%, or about 1 wt-% to about 10 wt-%. In addition, without being limited according to the disclosure, all ranges recited are inclusive of the numbers defining the range and include each integer within the defined range.

### Additional Functional Ingredients

The components of the aqueous compositions can further be combined with various functional components suitable for uses disclosed herein, including floorcare applications. In some embodiments, the aqueous compositions including the nonionic alcohol alkoxylate surfactant, organic polymer(s) free of zinc cross-link agents, plasticizing agent, and solvent(s) make up a large amount, or even substantially all of the total weight of the aqueous compositions. In further embodiments, the aqueous compositions including the nonionic alcohol alkoxylate surfactant, organic polymer(s) free of zinc cross-link agents, plasticizing agent, solvent(s), coalescent and/or cosolvent make up a large amount, or even substantially all of the total weight of the aqueous compositions. For example, in some embodiments few or no additional functional ingredients are disposed therein.

In other embodiments, additional functional ingredients may be included in the aqueous compositions. The functional ingredients provide desired properties and functionalities to the compositions. For the purpose of this application, the term “functional ingredient” includes a material that when dispersed or dissolved in a use and/or concentrate solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the aqueous compositions may include a cosolvent and/or coalescent, a wax component or mixture of waxes, a buffer, buffers, defoaming agents, wetting agents, stabilizers, biocides, preservatives, anti-slip agents, gloss-enhancing agents, performance enhancers, whitening agents, polycarbonates, anti-soiling or a stain blocking agents, matting agents, or combination thereof.

In a preferred embodiment, the aqueous composition comprises at least one additional functional ingredient. In further preferred embodiments, the additional functional ingredient comprises a wax component or mixture of waxes, preservative, wetting agent, defoamer, gloss-enhancing agent, or a combination thereof.

According to embodiments of the disclosure, the various additional functional ingredients may be provided in the aqueous composition in the amount from about 0 wt-% to about 50 wt-%, from about 0.01 wt-% to about 50 wt-%, from about 0.1 wt-% to about 40 wt-%, from about 1 wt-% to about 40 wt-%, from about 1 wt-% to about 30 wt-%, or from about 1 wt-% to about 20 wt-%. In addition, without being limited according to the disclosure, all ranges recited are inclusive of the numbers defining the range and include each integer within the defined range.

### Wax(s)

The aqueous compositions preferably comprise a wax component or mixture of waxes. The waxes, wax emulsions, and wax dispersions or mixtures of waxes that can be used include waxes of a vegetable, animal, synthetic, and/or mineral origin. Representative waxes include, for example, camuba, candelilla, lanolin, stearin, beeswax, oxidized polyethylene wax, polyethylene emulsions, polypropylene, copolymers of ethylene and acrylic esters, hydrogenated coconut oil or soybean oil, and the mineral waxes such as paraffin or ceresin.

The wax component can be a water insoluble oil, a wax, or a mixture of a water insoluble oil and a wax. The wax component can be available for incorporation into the wax composition in a “solid” form, as a liquid, or as an emulsion in a solvent such as water. It should be understood that the characterization of the wax component as a “solid” refers to the general absence of solvent such as water in an amount that causes the wax component to be in the form of a liquid. Exemplary water insoluble oils that can be used include mineral oils, linear paraffins, branched paraffins, alkyl methyl esters, soy oil, and other natural oils. In addition, the wax component can be provided as mixtures of various water insoluble oils, mixtures of various waxes, and mixtures of water insoluble oils and waxes. It should be understood that certain waxes can be provided as blends of various waxes and are not necessarily provided as a “pure” wax.

In some embodiments, the wax component or mixture of waxes is included in the composition at an amount of at least about 0.1 wt-% to about 10 wt-%, about 1 wt-% to about 10 wt-%, or from about 2 wt-% to about 10 wt-%. In addition, without being limited according to the disclosure, all ranges recited are inclusive of the numbers defining the range and include each integer within the defined range.

### Methods of Use

The aqueous compositions are suited for use as floor finishes and finishing other hard surfaces and objects in consumer and institutional settings. The compositions do not provide a permanent finish on the floor and instead are semi-permanent coatings in that they are not removed or stripped until needed while additional coatings are applied over time. The compositions can be used for cleaning, enhancing gloss, providing soil resistance and/or increasing anti-slip properties of a surface. These applications further benefit from compositions free of fluoro-surfactants and/or fluoro-polymers providing a safer floor finish application compared to the state of the art.

Various hard surfaces, namely floor surfaces can be treated with the aqueous compositions. Hard surfaces and floor substrates can be either a porous surface or a non-porous surface.

Exemplary floor substrates include, for example, resilient substrates such as sheet goods (e.g., vinyl flooring, linoleum or rubber sheeting), vinyl composite tiles, vinyl asbestos tiles, rubber tiles, cork and synthetic sports floors, and non-resilient substrates such as concrete, stone, marble, wood, bamboo, ceramic tile, grout, Terrazzo and other poured or “dry shake” floors. The aqueous compositions may be jobsite-applied to a flooring substrate after the substrate has been installed (e.g., to monolithic flooring substrates such as sheet vinyl goods, linoleum, cork, rubber sheeting, synthetic sports floors, concrete, stone, marble, grout or Terrazzo, or to multipiece flooring substrates such as vinyl composite tiles, wood floorboards or ceramic tiles), or can be factory-applied to a flooring substrate before it is installed (e.g., to monolithic flooring substrates such as sheet vinyl goods in roll form, or multipiece flooring substrates such as vinyl composite tiles or wood floorboards). Jobsite application is preferred, with suitable jobsites including indoor and outdoor sites involving new or existing residential, commercial and government- or agency-owned facilities.

The aqueous compositions may also be used as a restorer composition to restore gloss to a floor or other hard surface. This would involve a dilution to desired performance levels, spray application to the floor and buffing. Such uses generally include a 1 to 10 dilution depending on the desired performance level. Use of the finish composition as a restorer cleans and restores floors to a high gloss, reducing the need for more expensive, time-consuming stripping and recoating.

The aqueous compositions can be applied using a variety of methods and tools, including spraying, brushing, flat or string mopping, roll coating, applying with a paint roller, applying with a T-bar applicator, and flood coating. Mop application, especially flat mopping, is preferred for coating most floors.

The aqueous compositions are applied to a hard surface, such as a floor substrate. Typically, the floor should first be cleaned and any loose debris removed. In some embodiments, no undercoat layer or coat is applied to the floor. In other embodiments, one or more undercoat layers or coats (diluted if necessary with water or another suitable diluent, plasticizer, coalescent or cosolvent) may be applied to the floor. In yet other embodiments, one or more topcoat layers may be applied.

The applying of the aqueous compositions to a hard surface apply the aqueous composition in an amount from about 15 wt-% to about 35 wt-% solids, or about 20 wt-% to about 35 wt-% solids.

When multiple undercoat, or top coat layers are employed they can be the same or different. Each undercoat layer preferably will have a dry coating thickness of about 2.5 to about 25 microns, more preferably about 2.5 to about 15 microns. Preferably the overall undercoat dry coating thickness will be about 5 to about 100 microns, and more preferably about 5 to about 50 microns. If an undercoat is used, a topcoat may also be used. The topcoat may be the same as the undercoat or may be different. When a topcoat is used, one to seven layers typically will be preferred. Each topcoat layer will preferably have a dry coating thickness of about 2.5 to about 100 microns, more preferably from about 2.5 to 60 microns.

In embodiments the aqueous composition (or a dilution thereof) is applied at a range of about 10 to about 120 milliliters of the composition to each square meter of the floor, or about 20 to about 100 milliliters of the composition to each square meter of the floor.

In some embodiments a typical application rate of the compositions is 2000 square feet per gallon, but other rates may be used depending upon the floor surface, leveling, and desired performance.

The aqueous composition can be applied using an applicator device, such as a mop. Examples of applicator devices include, for example, an applicator wand, mop, brush, and/or wipe. In a preferred embodiment an applicator device can further comprise a micro fiber, foam, cotton, and/or other natural fiber and/or synthetic material application surface.

Some non-limiting examples of suitable mop heads include string mops such as those available from Amsan; and flat mops such as those available from Rubbermaid, Unger or Ecolab. Mop heads typically comprise a plurality of flexibility fibrous units that can absorb and distribute the aqueous composition. The mop head material can be made of for example, cotton, rayon, polyester, nylon or a combination thereof. The mop head is preferably a flat mop made of polyester and nylon microfiber.

The aqueous compositions applied according to the methods described herein beneficially provide a treated floor surface with an increase in 60 gloss of at least about 80 gloss units (GU) after the composition is applied after 4 or more coats, or in preferred embodiments after 5 coats, which a skilled artisan appreciates will change with each coat applied.

### Kits

The aqueous compositions can be provided in a kit form as well. A kit can comprise the aqueous composition, a container and/or applicator device for the aqueous composition, and optionally instructions for use thereof.

### Embodiments

The present disclosure is further defined by the following numbered embodiments:

1. An aqueous composition comprising: a nonionic alcohol alkoxylate surfactant; organic polymer(s) or copolymers free of zinc cross-link agents comprising (i) styrene or vinyl toluene and at least one monoethylenically unsaturated acid or anhydride, (ii) acrylic polymers or modified acrylic polymers, or (iii) combinations thereof; a plasticizing agent comprising tributoxyethyl phosphate and benzoate esters; and a solvent; wherein the composition is free of fluoro-surfactants and/or fluoro-polymers; and wherein the composition comprises between about 15 wt-% to about 35 wt-% of solids.

2. The composition of embodiment 1, wherein the nonionic alcohol alkoxylate surfactant comprises from about 0.01 wt-% to about 5 wt-%, or from about 0.1 wt-% to about 5 wt-% of the composition.

3. The composition of any one of embodiments 1-2, wherein the nonionic alcohol alkoxylate surfactant is an alcohol ethoxylate surfactant with the formula R₂—O-(EO)ₓ—H, wherein R₂ is a C10-C14 alkyl, or preferably a C12-C14 alkyl, and wherein x is 3-9, or preferably 3-6.

4. The composition of any one of embodiments 1-3, wherein the organic polymer or copolymers comprises from about 20 wt-% to about 60 wt-%, or from about 30 wt-% to about 60 wt-% of the composition.

5. The composition of any one of embodiments 1-4, wherein the organic polymer or copolymers comprises a homopolymer or copolymer of acrylic and methacrylic acids (or modified acrylic and methacrylic acids), a copolymer of styrene and at least one member selected from the group consisting of acrylic and methacrylic acids (or modified acrylic and methacrylic acids), and/or a homopolymer or copolymer of vinyl acetate, and preferably wherein the organic polymer is a poly(acrylic/styrene) emulsion.

6. The composition of any one of embodiments 1-5, wherein the plasticizing agent comprises from about 0.1 wt-% to about 10 wt-%, or from about 0.5 wt-% to about 10 wt-% of the composition.

7. The composition of any one of embodiments 1-6, wherein the plasticizing agent comprises from about 40 wt-% to about 60 wt-% of the tributoxyethyl phosphate and from about 40 wt-% to about 60 wt-% of the benzoate esters.

8. The composition of any one of embodiments 1-7, wherein the organic polymer or copolymers comprises from about 30 wt-% to about 50 wt-% of the composition, wherein the nonionic alcohol alkoxylate surfactant comprises from about 0.1 wt-% to about 2 wt-% of the composition, wherein the plasticizing agent comprises from about 0.5 wt-% to about 5 wt-% of the composition, and wherein the solvent and optionally the coalescent and/or cosolvent comprise from about 20 wt-% to about 80 wt-% of the composition.

9. The composition of any one of embodiments 1-8, further comprising at least one additional functional ingredient selected from the group consisting of a cosolvent and/or coalescent, a wax component or mixture of waxes, a buffer, a defoamer, a wetting agent, a stabilizer, a biocide, a preservative, an anti-slip agent, a gloss-enhancing agent, a performance enhancer, a whitening agent, polycarbonate, an anti-soiling or a stain blocking agent, a matting agent, or combination thereof, and preferably wherein the at least one additional functional ingredient comprises a wax component or mixture of waxes, preservative, wetting agent, defoamer, or a combination thereof.

10. The composition of embodiment 9, wherein the at least one additional functional ingredient comprises from about 0.01 wt-% to about 50 wt-% of the composition.

11. The composition of embodiment 9 or 10, wherein the additional functional ingredient comprises a wax component or mixture of waxes, and/or further comprising from about from about 0.1 wt-% to about 10 wt-% of a wax component or mixture of waxes in the composition.

12. The composition of any one of embodiments 9-11, further comprising a cosolvent comprising a glycol ether.

13. The composition of any one of embodiments 1-12, wherein said composition comprises less than 1% volatile organic compounds (VOC).

14. A method for cleaning a hard surface, preferably a floor surface comprising: applying an aqueous composition according to any one of embodiments 1-13 to the hard surface or floor surface.

15. The method of embodiment 14, wherein the aqueous composition is applied having from about 15 wt-% to about 35 wt-% solids, or about 20 wt-% to about 35 wt-%.

16. The method of any one of embodiments 14-15, wherein the floor surface is a porous surface or a non-porous surface.

17. The method of any one of embodiments 14-16, wherein the composition is applied as a factory applied coating or a job-site applied coating.

18. The method of any one of embodiments 14-17, wherein the treated floor surface has an increase in 60° gloss of at least about 80 gloss units (GU) after the composition is applied in 4 or more coats to the floor surface.

19. The method of any one of embodiments 14-18, wherein the composition is applied at a range of about 10 to about 120 milliliters of the composition to each square meter of the floor, or about 20 to about 100 milliliters of the composition to each square meter of the floor.

20. The method of any one of embodiments 14-19, wherein the composition is applied with an applicator device.

21. The method of embodiment 20, wherein the applicator device comprises an applicator wand, mop (e.g. string mop), brush, and/or wipe.

22. The method of embodiments 21, wherein the applicator device further comprises a micro fiber, foam, cotton, and/or other natural fiber and/or synthetic material application surface.

23. A kit comprising: an aqueous composition according to any one of embodiments 1-13; a container and/or applicator device; and optionally instructions for use of the kit.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The materials used in the following Examples are provided herein:

Inline formula 1: commercially available fluoro-polymer-containing hard surface cleaner with organic polymers containing zinc cross-linking agents.

Inline formula 2: commercially available fluoro-polymer-containing hard surface cleaner with organic polymers containing zinc cross-linking agents.

Rhoplex 3949: modified acrylic polymer available from Dow.

Mor-Glo G128: styrene-acrylic copolymer with calcium cross-linking agents available from Synthomer.

LUTENSOL TDA 3: A tridecyl alcohol ethoxylate, 3EO, available from BASF Corp.

LUTENSOL TDA 6: A tridecyl alcohol ethoxylate, 6EO, available from BASF Corp.

LUTENSOL TDA 9: A tridecyl alcohol ethoxylate, 9EO, available from BASF Corp.

The evaluated compositions are summarized in Table 2.

TABLE 2

| | Inline | Inline | Aqueous | Aqueous |
|---|---|---|---|---|
| | formula | formula | composition | composition |
| Material | 1 | 2 | 1 | 2 |
| Fluoro-surfactant | 0.01-0.5 | 0.01-0.5 | | |
| Nonionic alcohol | | | 0.01-0.5 | 0.01-0.5 |
| alkoxylate surfactant | | | | |
| Organic Polymer(s) | 40-45 | 40-45 | 40-45 | 40-45 |
| without zinc | | | | |
| cross-link agents | | | | |
| Organic | | 2-5 | | 2-5 |
| Polymer(s) - | | | | |
| Rhoplex 3949 | | | | |
| Plasticizing | 1-5 | 1-5 | 1-5 | 1-5 |
| Agent(s) - | | | | |
| TBEP/benzoate | | | | |
| esters | | | | |
| Wax emulsions | 3-6 | 3-6 | 3-6 | 3-6 |
| Water and | 45-50 | 48-52 | 45-50 | 48-52 |
| co-solvents | | | | |
| Additional | 0-50 | 0.01-50 | | 1-20 |
| Functional | | | | |
| Ingredients | | | | |
| Total | 100 | 100 | 100 | 100 |

### Example 1

The floorcare and hard surface aqueous compositions according to embodiments of the invention (aqueous composition 1 and aqueous composition 2) were measured against an inline formula 1 and an inline formula 2 for coating adhesion on ceramic tiles.

Tiles were coated with 5 coats with at least 1 hour between coats at a temperature of about 68-72° F. at 25-50% relative humidity with the aqueous compositions and inline formulas, then dried and cured for over one week. 5 coats represents a stressed testing condition as commercial applications conventionally do not advise to apply more than 4 coats. The tiles were then cut with a blade at an angle of approximately 15-20 degrees to the tile and dragged against the coated tiles at constant pressure for approximately one inch for 6 separate lines. The cutting procedure was repeated at approximately 90 degrees from the first cutting with the blade to result in a square grid pattern across the surface of the coated tiles.

A piece of tape was cut and placed atop the cut square grid and firmly pressed to adhere the tape to the cut and coated surface. Once the tape was adhered, it was quickly removed to determine if any of the coating on the tiles was also removed. The coated tiles were then visually evaluated for any percent area of removal of the coatings and classified “5B” if 0% of the coatings were removed, “4B” if less than 5% of the coatings were removed, “3B” if 5-15% of the coatings were removed, “2B” if 15-35% of the coatings were removed, “1B” if 35-65% of the coatings were removed, and “0B” if greater than 65% of the coatings were removed from the tiles.

The tiles were further evaluated as “dry” in which the tiles were immediately cut after curing for one week (as described in the procedure above); “cut wet” in which the tiles were cut, then soaked in water for one hour, wiped to remove the water, then taped and tested; and “wet cut” in which the tiles were soaked in water for one hour, wiped to remove the water, then cut, taped, and tested. Table 3 shows the comparison between aqueous composition 1 and inline formula 1 and Table 4 shows the comparison between aqueous composition 2 and inline formula 2.

TABLE 3

| Formula | Dry | Cut Wet | Wet Cut |
|---|---|---|---|
| Inline | 5B | 5B | 5B |
| Formula 1 | 5B | 5B | 5B |
| | 5B | 5B | 5B |
| Aqueous | 5B | 5B | 5B |
| Composition 1 | 5B | 5B | 5B |
| | 5B | 5B | 5B |

TABLE 4

| Formula | Dry | Cut Wet | Wet Cut |
|---|---|---|---|
| Inline | 4B | 4B | 5B |
| Formula 2 | 5B | 5B | 5B |
| | 5B | 5B | 5B |
| Aqueous | 5B | 5B | 5B |
| Composition 2 | 5B | 5B | 5B |
| | 5B | 5B | 5B |

Tables 3 and 4 show that the aqueous compositions provide equivalent adhesion performance of the coatings on tiles as the inline formulas.

### Example 2

The aqueous compositions of the present invention were additionally compared to inline formulas to evaluate black heel marking characteristics on coated tiles. Tiles were initially coated 5 times with the aqueous compositions and inline formulas and cured for at least one week at room temperature (approximately 70° F.). The coated tiles were then loaded into a Snell capsule that contains 6 cubes of shoe rubber, which when the coated tiles are attached to the inside walls of the Snell capsule, the rubber cubes tumble against the coated tiles for 2.5 minutes in each rotational direction (5 total minutes of tumbling). The tiles are then removed from the Snell capsule and digitally imaged. A percent area of black marks on the surface of the coated tiles is calculated via the digital image

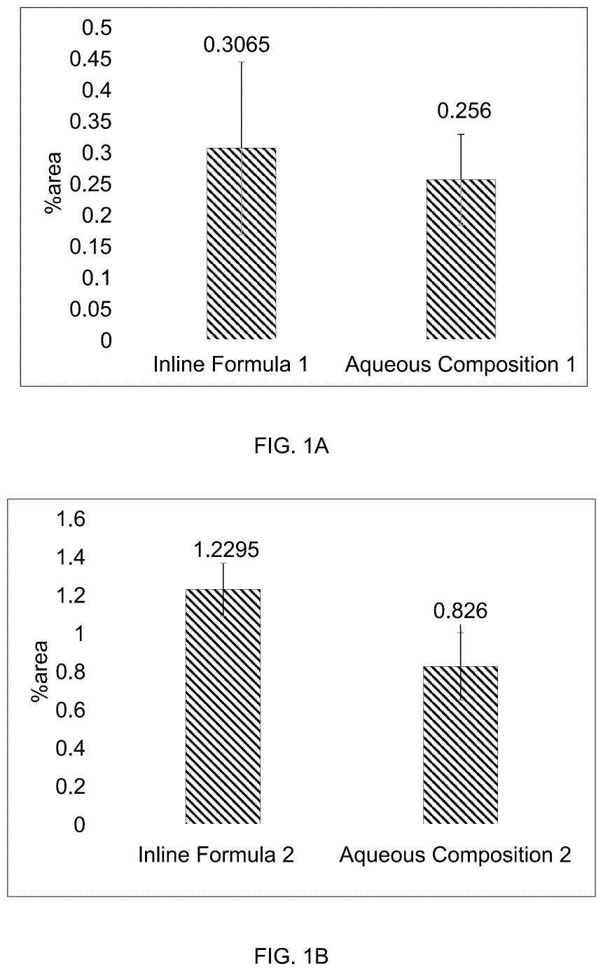

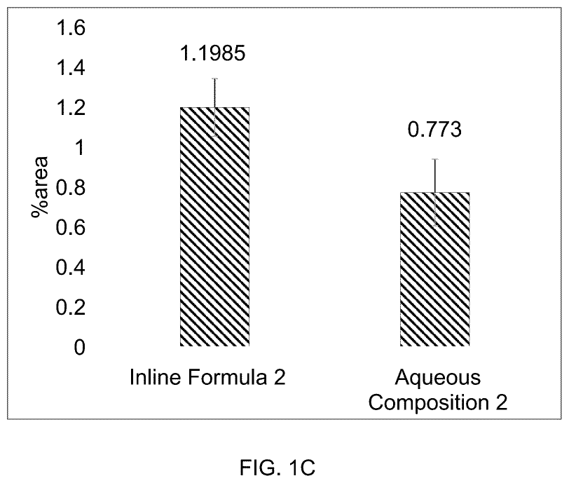

FIGS. 1A-C compare the aqueous compositions and inline formulas for percent area of black marks on the surface of the tiles. As each of these figures show, the aqueous compositions were more successful in having a lower amount of black shoe rubber marks than the inline formulas showing an improvement in the film coating with the aqueous compositions using the nonionic surfactant in place of the fluoro-surfactant of the inline formulations.

For the testing there are two different thresholds for determining whether a pixel is “dark” enough to be counted as part of a black heel mark. The lighter threshold, which results in more pixels being counted, corresponds to the “all heel marks” result (evaluated in FIG. 1B), while the darker threshold, which results in fewer pixels being counted, corresponds to the “dark heel marks” result (evaluated in FIG. 1C). The calculated areas for “all heel marks” and “dark heel marks” are very similar and show the same trend of improved markings, meaning less marking on the floors treated with the aqueous composition according to the claimed invention.

### Example 3

The aqueous compositions and inline formulas were further compared to measure the gloss and the distinctness of image (DOI). Tiles were coated with the evaluated aqueous compositions that are fluoro-surfactant free compared to inline formulas. The tiles were evaluated after each coating for gloss at approximately 20°, 60°, and 85° from the surface of the coated tile. Similarly, the tiles were evaluated after each coating for DOI.

Aqueous compositions 1 and 2, and inline formulas 1 and 2, were evaluated at 68° F. and 30% humidity. Tables 5 and 6 show gloss and DOI for inline formula 1 and aqueous formula 1, respectively, using formula samples kept at room temperature. Tables 7 and 8 show gloss and DOI for inline formula 2 and aqueous formula 2, respectively, using formula samples kept at room temperature.

Tables 9 and 10 show gloss and DOI for inline formula 1 and aqueous formula 1, respectively, after 4 weeks at 50 C. Tables 12 and 13 show gloss and DOI for inline formula 2 and aqueous formula 2, respectively, after 4 weeks at 50 C.

The gloss of the surfaces treated with the compositions are determined by measuring the light reflectance of the surfaces at varying degrees (20°, 60°, and) 85° using a Micro-TRI-Gloss meter available from BYK-Gardner, Columbia, Md.

TABLE 5

| | Inline Formula 1 (0.2% TDA 6), 0 wks stability | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 8.7 | 1.1 | 34.1 | 3.5 | 53.3 | 3.0 | 27.6 | 0.3 |
| 2 | 23.8 | 2.5 | 59.1 | 2.9 | 73.5 | 2.0 | 34.5 | 2.9 |
| 3 | 37.8 | 2.7 | 73.0 | 1.8 | 83.4 | 1.4 | 44.0 | 1.3 |
| 4 | 46.8 | 2.7 | 80.4 | 1.4 | 89.2 | 1.1 | 52.9 | 5.6 |
| 5 | 59.6 | 1.9 | 86.3 | 0.7 | 93.4 | 1.1 | 51.8 | 2.2 |
| 24 hr | 53.0 | 3.0 | 85.6 | 0.4 | 91.5 | 1.5 | 51.5 | 4.0 |
| dry | | | | | | | | |

TABLE 6

| | Aqueous Formulation 1 (0.2% TDA 6), 0 wks stability | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 7.8 | 1.0 | 36.3 | 2.6 | 53.3 | 2.1 | 26.6 | 0.5 |
| 2 | 19.1 | 4.8 | 54.9 | 4.6 | 70.1 | 2.6 | 32.2 | 2.1 |
| 3 | 31.5 | 5.5 | 69.7 | 3.3 | 79.4 | 2.2 | 40.8 | 4.4 |
| 4 | 46.2 | 6.0 | 80.4 | 2.2 | 86.1 | 2.0 | 45.1 | 2.1 |
| 5 | 48.5 | 6.3 | 84.5 | 1.7 | 92.5 | 1.0 | 48.9 | 2.7 |
| 24 hr | 60.1 | 2.3 | 87.3 | 0.8 | 93.3 | 1.0 | 50.6 | 3.7 |
| dry | | | | | | | | |

TABLE 7

| | Inline Formula 2 (0.2% TDA 6), 0 wks stability | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 3.6 | 0.6 | 21.7 | 2.2 | 40.7 | 1.7 | 26.1 | 0.3 |
| 2 | 18.0 | 1.6 | 52.2 | 1.1 | 63.1 | 1.8 | 27.9 | 0.9 |
| 3 | 24.9 | 2.5 | 63.1 | 2.7 | 72.8 | 2.0 | 30.6 | 2.7 |
| 4 | 33.9 | 2.5 | 74.5 | 1.4 | 82.4 | 0.7 | 33.8 | 4.1 |
| 5 | 43.4 | 3.8 | 80.6 | 2.1 | 86.1 | 1.4 | 44.0 | 7.4 |
| 24 hr | 43.1 | 4.2 | 81.1 | 2.3 | 86.9 | 1.1 | 34.8 | 3.8 |
| dry | | | | | | | | |

TABLE 8

| | Aqueous Composition 2 (0.2% TDA 6), 0 wks stability | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 5.7 | 1.2 | 28.6 | 3.1 | 44.8 | 1.7 | 26.2 | 0.3 |
| 2 | 18.1 | 2.4 | 54.0 | 2.5 | 66.1 | 1.8 | 28.0 | 0.8 |
| 3 | 28.0 | 3.2 | 65.9 | 2.9 | 77.0 | 2.0 | 32.1 | 0.8 |
| 4 | 43.3 | 3.7 | 77.7 | 2.2 | 83.9 | 1.6 | 40.4 | 1.5 |
| 5 | 58.3 | 4.3 | 86.3 | 1.5 | 91.5 | 0.4 | 45.9 | 3.7 |
| 24 hr | 50.1 | 1.5 | 83.3 | 0.9 | 87.1 | 1.3 | 36.4 | 5.6 |
| dry | | | | | | | | |

TABLE 9

| | Inline Formulation 1 (0.2% TDA 6), 4 wks at 50 C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 9.4 | 0.9 | 36.7 | 1.7 | 57.3 | 1.2 | 26.6 | 0.4 |
| 2 | 21.3 | 2.4 | 54.3 | 2.1 | 71.1 | 1.2 | 31.3 | 1.5 |
| 3 | 31.0 | 2.1 | 65.5 | 1.9 | 79.8 | 1.2 | 36.6 | 4.2 |
| 4 | 41.1 | 1.5 | 75.8 | 1.5 | 87.4 | 1.2 | 36.6 | 3.5 |
| 5 | 50.3 | 3.9 | 84.0 | 1.5 | 93.5 | 0.7 | 47.4 | 4.0 |
| 24 hr | 49.4 | 3.5 | 84.0 | 1.4 | 93.1 | 0.9 | 44.9 | 5.3 |
| dry | | | | | | | | |

TABLE 10

| | Aqueous Formulation 1 (0.2% TDA 6), 4 wks at 50 C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 8.6 | 0.3 | 38.0 | 1.2 | 56.6 | 1.3 | 27.0 | 0.9 |
| 2 | 28.0 | 2.2 | 62.4 | 1.8 | 74.8 | 1.2 | 32.9 | 0.6 |
| 3 | 40 | 2.5 | 73.6 | 1.4 | 84.9 | 1.1 | 39.8 | 3.4 |
| 4 | 52.6 | 5.6 | 81.7 | 1.9 | 91.0 | 0.3 | 50.0 | 1.0 |
| 5 | 58.5 | 2.3 | 86.8 | 1.1 | 93.8 | 0.6 | 46.1 | 2.8 |
| 24 hr | 63.4 | 1.3 | 88.6 | 0.4 | 94.9 | 0.2 | 47.8 | 4.6 |
| dry | | | | | | | | |

TABLE 11

| | Inline Formula 2 (0.2% TDA 6), 4 wks at 50 C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 4.7 | 0.6 | 25.8 | 1.8 | 46.3 | 1.5 | 26.2 | 0.3 |
| 2 | 16.6 | 2.2 | 52.6 | 2.6 | 67.6 | 0.9 | 28.4 | 0.6 |
| 3 | 35.4 | 2.2 | 70.7 | 1.4 | 79.8 | 0.8 | 23.1 | 16.9 |
| 4 | 45.5 | 3.4 | 78.1 | 2.2 | 86.1 | 1.1 | 40.3 | 0.7 |
| 5 | 55.1 | 2.6 | 84.0 | 0.7 | 90.7 | 0.9 | 44.2 | 2.3 |
| 24 hr | 52.3 | 2.8 | 82.3 | 1.1 | 89 | 0.8 | 43.2 | 0.9 |
| dry | | | | | | | | |

TABLE 12

| | Aqueous Formulation 2 (0.2% TDA 6), 4 wks at 50 C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev. |
| 1 | 5.2 | 0.5 | 29.2 | 0.8 | 50.5 | 0.6 | 26.5 | 0.1 |
| 2 | 20.9 | 0.5 | 57.9 | 0.5 | 73.5 | 1.5 | 29.0 | 0.2 |
| 3 | 35.8 | 2.1 | 73.0 | 0.7 | 82.4 | 0.2 | 34.0 | 2.3 |
| 4 | 51.8 | 1.4 | 81.7 | 0.8 | 90.5 | 1.1 | 41.2 | 2.0 |
| 5 | 66.2 | 0.8 | 87.4 | 0.8 | 93.7 | 0.3 | 47.7 | 2.8 |
| 24 hr | 59 | 2.3 | 85.9 | 1 | 91.5 | 0.3 | 43.8 | 3.3 |
| dry | | | | | | | | |

Additional testing of aqueous compositions 3 and 4 was completed as a further comparison to the results in Tables 5-12. The aqueous compositions replaced TDA 6 with TDA 3 and TDA 9, respectively in aqueous compositions 3 and 4 (with all other components of the compositions remaining the same). Tables 13 and 14 show gloss and DOI for the aqueous formulas 3 and 4, respectively, using formula samples kept at room temperature.

TABLE 13

| Aqueous Formulation 3 (0.2% TDA 3) | | |
|---|---|---|
| 20 Degree | 60 Degree | 85 Degree |

| | | St. | | St. | | St. |
|---|---|---|---|---|---|---|
| Coat # | Avg. | Dev. | Avg. | Dev. | Avg. | Dev. |
| 0 | — | — | — | — | — | — |
| 1 | 5.6 | 0.9 | 27.3 | 2.3 | 47.6 | 2.1 |
| 2 | 17.9 | 3 | 52.1 | 3.9 | 69.4 | 1.6 |
| 3 | 37.1 | 2.4 | 75.3 | 1.9 | 86.9 | 1.3 |
| 4 | 44.3 | 4.6 | 76.7 | 3.0 | 87.2 | 1.6 |
| 5 | 58.7 | 5.9 | 84.0 | 1.9 | 92.0 | 1.3 |
| 24 hr | 54.6 | 4.5 | 83.5 | 1.9 | 91.6 | 1.3 |

TABLE 14

| | Aqueous Formulation 4 (0.2% TDA 9) | | | | | |
|---|---|---|---|---|---|---|
| | 20 Degree | | 60 Degree | | 85 Degree | |
| Coat # | Avg. | St. Dev. | Avg. | St. Dev. | Avg. | St. Dev. |
| 0 | — | — | — | — | — | — |
| 1 | 5.5 | 0.9 | 28.0 | 3.3 | 47.4 | 2.8 |
| 2 | 17.4 | 2.1 | 52.2 | 3.7 | 68.8 | 2.5 |
| 3 | 30.3 | 2.6 | 68.5 | 2.2 | 80.1 | 2.0 |
| 4 | 43.9 | 4.2 | 77.1 | 2.1 | 87.8 | 1.5 |
| 5 | 57.9 | 1.5 | 83.9 | 1.3 | 90.9 | 1.2 |
| 24 hr | 47.1 | 7.6 | 80.5 | 2.9 | 88.8 | 1.5 |

The results in Tables 13-14 show that the TDA 3 and TDA 9 nonionic alcohol ethoxylate does not perform as well as the TDA 6 in aqueous formulation 1 and 2. Both the gloss and appearance of formulations containing TDA 6 look better than formulations 3 and 4 shown in Tables 13 and 14, respectively.

Beneficially the results show that the gloss and DOI values achieved by the Aqueous Compositions according to the invention are equivalent or superior to the inline formulas. The removal of the fluorosurfactant and replacement in the formulations did not result in any negative performance effects including no negative impact in visual coatings nor any other negative performance.

In addition to the data shown in the above tables evaluating gloss after 4 weeks at 50° C., additional stability testing of the aqueous compositions of the present invention were compared to inline formulas for long term coating stability on floor surfaces. The aqueous compositions and inline formulas were applied to vinyl composite tiles (VCT) which are black floor tiles with 5 coats at 50° C., with 60 minutes between each coat of application. The floor tiles were then visually evaluated for stability at 2 weeks, 4 weeks, and 8 weeks. The aqueous compositions visually performed as good or better than the inline formulas in assessing visual appearance, including shine, evenness or the leveling lines, haziness, imperfections, etc.

### Example 4

The aqueous compositions were further compared to the inline formulas and measured for the coefficient of friction (COF) on coated tiles. Tiles were coated with the aqueous compositions and inline formulas. Aqueous composition 1 and inline formula 1 were applied to the tiles with 2 coats, aqueous composition 2 and inline formula 2 were applied in 1 coat on the tiles. The COF was measured after 2 coats. The coating was applied as close to 68° F., 35% relative humidity, with 1 hour or more between each coat and allowed to cure for 24 hours.

After drying, the coated tiles were then measured for the coefficient of friction with a James Machine following the instrument instructions for use. Table 15 shows the coefficient of friction measurements of aqueous composition 1 and inline formula 1 at 67° F. and 33% humidity. Table 16 shows the coefficient of friction measurements of aqueous composition 2 and inline formula 2 at 68° F. and 34% humidity.

TABLE 15

| Formula | COF1 | COF2 | COF3 | COF4 | Avg COF |
|---|---|---|---|---|---|
| Inline | 0.62 | 0.62 | 0.59 | 0.58 | 0.6025 |
| Formula 1 | | | | | |
| Aqueous | 0.62 | 0.61 | 0.57 | 0.56 | 0.59 |
| Composition 1 | | | | | |

TABLE 16

| Formula | COF1 | COF2 | COF3 | COF4 | Avg COF |
|---|---|---|---|---|---|
| Inline | 0.7 | 0.74 | 0.74 | 0.75 | 0.7325 |
| Formula 2 | | | | | |
| Aqueous | 0.74 | 0.74 | 0.74 | 0.72 | 0.735 |
| Composition 2 | | | | | |

As shown in Tables 15 and 16, the coefficient of friction of the aqueous compositions is substantially similar to the inline formulas. Beneficially the results show that the removal of the fluorosurfactant and replacement in the formulations with the nonionic alcohol alkoxylate surfactant did not result in any negative performance effects.

### Example 5

The additional aqueous compositions 1-6 below were evaluated in Example 5.

TABLE 17

| | Aqueous | Aqueous | Aqueous | Aqueous | Aqueous | Aqueous |
|---|---|---|---|---|---|---|
| Material | Comp. 1 | Comp. 2 | Comp. | Comp. 4 | Comp. 5 | Comp. 6 |
| Fluoro- | — | — | — | — | — | — |
| surfactant | | | | | | |
| Nonionic | 0.01-0.5 | 0.01-0.5 | 0.01-0.5 | 0.01-0.5 | 0.01-0.5 | 0.01-0.5 |
| alcohol | | | | | | |
| alkoxylate | | | | | | |
| surfactant | | | | | | |
| Organic | 40-45 | 40-45 | 40-45 | 40-45 | 40-45 | 40-45 |
| Polymer(s) | | | | | | |
| without zinc | | | | | | |
| cross-link | | | | | | |
| agents | | | | | | |
| Organic | — | 2-5 | — | 2-5 | — | 2-5 |
| Polymer(s) - | | | | | | |
| Rhoplex 3949 | | | | | | |
| Plasticizing | 1-5 | 1-5 | 1-5 | 1-5 | 1-5 | 1-5 |
| Agent(s) - | | | | | | |
| TBEP/benzoate | | | | | | |
| esters | | | | | | |
| Wax emulsions | 3-6 | 3-6 | 3-6 | 3-6 | 3-6 | 3-6 |
| Water and co- | 45-50 | 48-52 | 45-50 | 48-52 | 45-50 | 48-52 |
| solvents | | | | | | |
| Additional | — | 1-20 | — | 1-20 | — | 1-20 |
| Functional | | | | | | |
| Ingredients | | | | | | |
| Total | 100 | 100 | 100 | 100 | 100 | 100 |
| Moles EO in | 6 | 6 | 3 | 9 | 9 | 3 |
| the Nonionic | | | | | | |
| alcohol | | | | | | |
| alkoxylate | | | | | | |
| surfactant | | | | | | |

The aqueous compositions 1-6 were further compared to measure the effect of the nonionic alcohol alkoxylate surfactant's moles of ethylene oxide on gloss and the distinctness of image (DOI). Tiles were coated with the evaluated aqueous compositions that are fluoro-surfactant free and comprised either 3, 6, or 9 moles of ethylene oxide. The tiles were evaluated after each coating for gloss at approximately 20°, 60°, and 85° from the surface of the coated tile. Similarly, the tiles were evaluated after each coating for DOI.

Aqueous compositions 1-6 were evaluated at 25% humidity and either 68° F. (room temperature; hereinafter “RT”) or 50° C. for 8 weeks. Tables 18 and 19 show gloss and DOI for Aqueous composition 1, using formula samples kept at RT and 50° C. Tables 20 and 21 show gloss and DOI for Aqueous composition 2, using formula samples kept at RT and 50° C. Tables 22 and 23 show gloss and DOI for Aqueous composition 3, using formula samples kept at RT and 50° C. Tables 24 and 25 show gloss and DOI for Aqueous composition 4, using formula samples kept at RT and 50° C. Tables 26 and 27 show gloss and DOI for Aqueous composition 5, using formula samples kept at RT and 50° C. Tables 28 and 29 show gloss and DOI for Aqueous composition 6, using formula samples kept at RT and 50° C.

The gloss of the surfaces treated with the compositions are determined by measuring the light reflectance of the surfaces at varying degrees (20°, 60°, and 85°) using a Micro-TRI-Gloss meter available from BYK-Gardner, Columbia, Md.

TABLE 18

| | Aqueous Formulation 1 (0.2% TDA 6) 8 wks at RT | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 8.1 | 0.8 | 36.9 | 2.1 | 58.4 | 1.5 | 26.1 | 0.4 |
| 2 | 25.1 | 2.0 | 63.5 | 1.4 | 78.2 | 0.2 | 32.1 | 0.6 |
| 3 | 45.9 | 2.2 | 78.3 | 0.9 | 88.1 | 0.8 | 43.9 | 2.7 |
| 4 | 57.3 | 4.1 | 85.0 | 0.7 | 92.6 | 0.4 | 51.8 | 1.7 |
| 5 | 64.5 | 3.5 | 88.2 | 0.7 | 93.9 | 0.8 | 47.8 | 5.2 |
| 72 hr | 58.6 | 4.1 | 87.9 | 0.8 | 93.3 | 0.6 | 52.3 | 1.6 |
| dry | | | | | | | | |

TABLE 19

| | Aqueous Formulation 1 (0.2% TDA 6) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 8.0 | 1.0 | 36.4 | 3.5 | 55.8 | 3.1 | 26.5 | 0.1 |
| 2 | 26.9 | 1.9 | 65.9 | 1.3 | 78.2 | 1.9 | 31.2 | 1.0 |
| 3 | 44.6 | 4.9 | 78.1 | 3.9 | 87.4 | 3.1 | 40.3 | 1.4 |
| 4 | 58.1 | 7.2 | 85.3 | 3.2 | 92.9 | 1.0 | 45.2 | 2.0 |
| 5 | 65.2 | 4.5 | 88.4 | 1.0 | 95.5 | 0.5 | 57.4 | 3.5 |
| 72 hr | 61.5 | 2.9 | 87.4 | 0.5 | 92.5 | 0.5 | 52.9 | 6.7 |
| dry | | | | | | | | |

TABLE 20

| | Aqueous Formulation 6 (0.2% TDA 3) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 5.1 | 0.5 | 25.0 | 1.9 | 47.4 | 2.5 | 26.1 | 0.4 |
| 2 | 18.3 | 1.9 | 54.2 | 2.1 | 69.7 | 1.8 | 29.4 | 0.4 |
| 3 | 37.8 | 3.1 | 71.8 | 2.0 | 81.4 | 1.7 | 38.4 | 2.0 |
| 4 | 51.8 | 3.5 | 80.2 | 1.2 | 89.8 | 0.7 | 43.9 | 3.6 |
| 5 | 55.6 | 3.7 | 84.0 | 1.7 | 92.7 | 0.6 | 49.1 | 3.0 |
| 72 hr | 52.8 | 2.1 | 81.8 | 1.7 | 90.0 | 0.9 | 45.6 | 1.2 |
| dry | | | | | | | | |

TABLE 21

| | Aqueous Formulation 2 (0.2% TDA 6) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 5.9 | 0.4 | 28.8 | 0.8 | 53.2 | 0.8 | 26.5 | 0.2 |
| 2 | 18.1 | 1.8 | 51.8 | 2.4 | 70.0 | 1.3 | 29.8 | 0.9 |
| 3 | 37.0 | 1.7 | 70.6 | 0.7 | 83.9 | 1.9 | 37.2 | 2.0 |
| 4 | 49.9 | 3.1 | 79.9 | 1.6 | 88.9 | 0.8 | 47.4 | 2.0 |
| 5 | 57.7 | 3.2 | 85.2 | 1.1 | 92.3 | 0.7 | 53.1 | 1.7 |
| 72 hr | 50.6 | 2.5 | 81.3 | 1.7 | 90.3 | 0.7 | 48.8 | 3.4 |
| dry | | | | | | | | |

TABLE 22

| | Aqueous Formulation 3 (0.2% TDA 3) 8 wks at RT | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 8.9 | 0.3 | 36.5 | 1.3 | 57.7 | 1.8 | 26.4 | 0.3 |
| 2 | 29.8 | 1.3 | 65.9 | 0.8 | 79.4 | 0.9 | 33.9 | 0.4 |
| 3 | 50.4 | 2.6 | 79.3 | 1.2 | 88.8 | 0.6 | 43.2 | 1.7 |
| 4 | 63.6 | 4.8 | 85.7 | 1.1 | 92.8 | 0.3 | 49.4 | 2.7 |
| 5 | 63.9 | 2.8 | 87.4 | 0.5 | 94.9 | 0.3 | 52.8 | 4.7 |
| 72 hr | 57.4 | 3.4 | 86.3 | 1.3 | 93.6 | 0.5 | 47.7 | 3.7 |
| dry | | | | | | | | |

TABLE 23

| | Aqueous Formulation 3 (0.2% TDA 3) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 6.9 | 0.6 | 33.3 | 1.9 | 60.8 | 2.8 | 26.6 | 0.0 |
| 2 | 25.8 | 1.6 | 64.4 | 1.7 | 81.7 | 1.8 | 32.2 | 0.7 |
| 3 | 41.6 | 3.2 | 76.9 | 2.9 | 87.0 | 1.0 | 39.2 | 2.8 |
| 4 | 57.1 | 4.8 | 85.9 | 2.1 | 93.1 | 0.9 | 46.4 | 1.6 |
| 5 | 58.7 | 3.5 | 87.9 | 0.6 | 96.1 | 0.5 | 49.6 | 1.8 |
| 72 hr | 58.6 | 4.2 | 87.4 | 1.4 | 94.1 | 0.9 | 51.8 | 0.5 |
| dry | | | | | | | | |

TABLE 24

| | Aqueous Formulation 4 (0.2% TDA 9) 8 wks at RT | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 4.2 | 0.6 | 24.0 | 2.1 | 47.8 | 1.8 | 26.1 | 0.3 |
| 2 | 17.0 | 1.9 | 53.1 | 2.5 | 71.7 | 1.2 | 29.0 | 0.6 |
| 3 | 41.0 | 2.8 | 76.3 | 1.8 | 85.0 | 1.7 | 38.4 | 2.0 |
| 4 | 46.3 | 3.3 | 78.8 | 2.0 | 89.1 | 1.3 | 49.6 | 0.5 |
| 5 | 55.3 | 3.6 | 84.2 | 1.8 | 91.5 | 1.4 | 49.6 | 2.4 |
| 72 hr | 54.1 | 1.7 | 85.9 | 0.7 | 92.2 | 0.9 | 42.7 | 3.2 |
| dry | | | | | | | | |

TABLE 25

| | Aqueous Formulation 4 (0.2% TDA 9) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 6.6 | 0.5 | 32.6 | 1.1 | 56.4 | 1.2 | 26.2 | 0.1 |
| 2 | 24.1 | 2.7 | 61.1 | 2.7 | 74.7 | 1.3 | 30.6 | 0.2 |
| 3 | 43.5 | 1.7 | 76.3 | 0.9 | 85.6 | 0.5 | 39.2 | 2.0 |
| 4 | 51.8 | 2.8 | 81.1 | 1.1 | 90.4 | 1.1 | 49.5 | 3.4 |
| 5 | 56.4 | 2.9 | 81.1 | 1.1 | 92.4 | 0.7 | 54.4 | 3.7 |
| 72 hr | 57.6 | 2.0 | 85.9 | 0.8 | 92.4 | 0.4 | 46.3 | 2.6 |
| dry | | | | | | | | |

TABLE 26

| | Aqueous Formulation 5 (0.2% TDA 9) 8 wks at RT | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 6.7 | 0.5 | 32.2 | 1.6 | 55.5 | 2.1 | 26.2 | 0.5 |
| 2 | 22.7 | 1.1 | 60.6 | 0.8 | 77.9 | 0.7 | 32.0 | 0.7 |
| 3 | 40.3 | 4.5 | 76.4 | 2.7 | 88.9 | 1.8 | 43.0 | 2.5 |
| 4 | 57.5 | 2.8 | 85.6 | 1.9 | 93.1 | 1.3 | 47.3 | 5.4 |
| 5 | 61.9 | 4.1 | 87.6 | 1.3 | 95.6 | 0.4 | 48.0 | 7.3 |
| 72 hr | 52.8 | 3.4 | 85.3 | 1.2 | 93.7 | 0.6 | 56.8 | 2.8 |
| dry | | | | | | | | |

TABLE 27

| | Aqueous Formulation 5 (0.2% TDA 9) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 7.7 | 0.4 | 34.5 | 1.5 | 59.0 | 2.3 | 26.8 | 0.2 |
| 2 | 28.5 | 1.6 | 66.6 | 1.8 | 80.9 | 1.5 | 36.1 | 1.5 |
| 3 | 49.3 | 2.7 | 80.8 | 1.2 | 90.9 | 0.6 | 45.4 | 2.4 |
| 4 | 60.3 | 2.1 | 86.5 | 0.9 | 94.3 | 1.0 | 55.1 | 3.1 |
| 5 | 69.3 | 3.3 | 90.5 | 1.4 | 96.5 | 1.2 | 58.1 | 2.2 |
| 72 hr | 63.3 | 3.1 | 90.1 | 1.8 | 96.1 | 0.9 | 52.4 | 3.7 |
| dry | | | | | | | | |

TABLE 28

| | Aqueous Formulation 6 (0.2% TDA 3) 8 wks at RT | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 6.1 | 0.6 | 29.4 | 1.9 | 53.0 | 1.6 | 26.1 | 0.1 |
| 2 | 19.7 | 1.2 | 56.3 | 2.0 | 71.7 | 2.7 | 30.2 | 0.9 |
| 3 | 38.1 | 2.8 | 72.5 | 2.8 | 83.5 | 2.5 | 39.7 | 1.2 |
| 4 | 55.1 | 3.5 | 82.1 | 2.5 | 90.5 | 1.4 | 48.7 | 0.8 |
| 5 | 64.3 | 1.6 | 86.1 | 0.6 | 93.0 | 0.3 | 53.4 | 6.5 |
| 72 hr | 52.7 | 2.4 | 82.4 | 1.6 | 89.5 | 1.2 | 49.3 | 7.2 |
| dry | | | | | | | | |

TABLE 29

| | Aqueous Formulation 6 (0.2% TDA 3) 8 wks at 50° C. | | | | | | | |
|---|---|---|---|---|---|---|---|---|
| | 20° gloss | | 60° gloss | | 85° gloss | | DOI | |
| | | St. | | St. | | St. | | St. |
| Coat # | Avg. | Dev. | Avg. | Dev. | Avg. | Dev. | Avg. | Dev |
| 1 | 6.3 | 0.2 | 30.2 | 1.0 | 53.3 | 1.7 | 26.6 | 0.5 |
| 2 | 16.6 | 1.9 | 51.9 | 2.5 | 69.3 | 1.6 | 30.8 | 0.1 |
| 3 | 36.7 | 1.3 | 72.4 | 0.8 | 82.7 | 1.6 | 37.2 | 1.4 |
| 4 | 52.6 | 2.4 | 82.4 | 1.1 | 90.1 | 3.1 | 50.7 | 1.4 |
| 5 | 57.8 | 3.4 | 85.0 | 1.1 | 90.0 | 0.9 | 51.9 | 3.8 |
| 72 hr | 49.9 | 1.1 | 82.6 | 1.0 | 89.8 | 1.6 | 46.5 | 1.9 |
| dry | | | | | | | | |

Tables 18-29 show that TDA 3 in Aqueous compositions 3 and 6 performed as well as TDA 6 in Aqueous compositions 1 and 2. TDA 3 and TDA 6 performed better than TDA 9. Without being limited be theory, it is thought that the shorter alkyl chain length of TDA 3 and TDA 6 imparts beneficial surface wetting characteristics as compared to the longer chain length of TDA 9.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. An aqueous composition comprising:
a nonionic alcohol alkoxylate surfactant;
organic polymer(s) or copolymers free of zinc cross-link agents comprising (i) styrene or vinyl toluene and at least one monoethylenically unsaturated acid or anhydride, (ii) acrylic polymers or modified acrylic polymers, or (iii) combinations thereof;
a plasticizing agent comprising tributoxyethyl phosphate and benzoate esters; and
a solvent;
wherein the composition is free of fluoro-surfactants and/or fluoro-polymers; and
wherein the composition comprises between about 15 wt-% to about 35 wt-% of solids.

2. The composition of claim 1, wherein the nonionic alcohol alkoxylate surfactant comprises from about 0.01 wt-% to about 5 wt-% of the composition.

3. The composition of claim 1, wherein the nonionic alcohol alkoxylate surfactant is an alcohol ethoxylate surfactant with the formula R₂—O-(EO)ₓ—H, wherein R₂ is a C10-C14 alkyl, and wherein x is 3-9.

4. The composition of claim 1, wherein the organic polymer or copolymers comprises from about 20 wt-% to about 60 wt-% of the composition.

5. The composition of claim 1, wherein the organic polymer or copolymers comprises a homopolymer or copolymer of acrylic and methacrylic acids (or modified acrylic and methacrylic acids), a copolymer of styrene and at least one member selected from the group consisting of acrylic and methacrylic acids (or modified acrylic and methacrylic acids), and/or a homopolymer or copolymer of vinyl acetate.

6. The composition of claim 1, wherein the plasticizing agent comprises from about 0.1 wt-% to about 10 wt-% of the composition.

7. The composition of claim 1, wherein the plasticizing agent comprises from about 40 wt-% to about 60 wt-% of the tributoxyethyl phosphate and from about 40 wt-% to about 60 wt-% of the benzoate esters.

8. The composition of claim 1, wherein the organic polymer or copolymers comprises from about 30 wt-% to about 50 wt-% of the composition, wherein the nonionic alcohol alkoxylate surfactant comprises from about 0.1 wt-% to about 2 wt-% of the composition, wherein the plasticizing agent comprises from about 0.5 wt-% to about 5 wt-% of the composition, and wherein the solvent and optionally the coalescent and/or cosolvent comprise from about 20 wt-% to about 80 wt-% of the composition.

9. The composition of claim 1, further comprising at least one additional functional ingredient selected from the group consisting of a cosolvent and/or coalescent, a wax component or mixture of waxes, a buffer, a defoamer, a wetting agent, a stabilizer, a biocide, a preservative, an anti-slip agent, a gloss-enhancing agent, a performance enhancer, a whitening agent, polycarbonate, an anti-soiling or a stain blocking agent, a matting agent, and combinations thereof.

10. The composition of claim 9, wherein the at least one additional functional ingredient comprises from about 0.01 wt-% to about 50 wt-% of the composition.

11. The composition of claim 10, further comprising a cosolvent comprising a glycol ether.

12. The composition of claim 1, wherein said composition comprises less than 1% volatile organic compounds (VOC).

13. A method for cleaning a hard surface, preferably a floor surface comprising:
applying an aqueous composition according to claim 1 to the hard surface or floor surface.

14. The method of claim 13, wherein the aqueous composition is applied having from about 15 wt-% to about 35 wt-% solids.

15. The method of claim 13, wherein the floor surface is a porous surface or a non-porous surface.

16. The method of claim 13, wherein the composition is applied as a factory applied coating or a job-site applied coating.

17. The method of claim 13, wherein the treated floor surface has an increase in 60° gloss of at least about 80 gloss units (GU) after the composition is applied in 4 or more coats to the floor surface and/or wherein the composition is applied at a range of about 10 to about 120 milliliters of the composition to each square meter of the floor.

18. The method of claim 13, wherein the composition is applied with an applicator device.

19. The method of claim 18, wherein the applicator device further comprises a micro fiber, foam, cotton, and/or other natural fiber and/or synthetic material application surface.

20. A kit comprising:
an aqueous composition according to claim 1;
a container and/or applicator device; and
optionally instructions for use of the kit.
